(19) United States
(12) Patent Application Publication
(10) Pub. No.: US 2020/0138055 A1
(43) Pub. Date: May 7, 2020

(54) PROCESSING OF A PRESS CAKE AND / OR POWDER OF OIL-CONTAINING SEEDS

(71) Applicant: Christian Schein, Melle (DE)

(72) Inventor: Christian Schein, Melle (DE)

(21) Appl. No.: 16/397,339

(22) Filed: Apr. 29, 2019

(30) Foreign Application Priority Data
Oct. 25, 2018 (EP) 18000828.6

(51) Int. Cl. A23J 1/14; A23J 3/22; A23L 33/185; A23P 30/20; A23J 3/26

(52) U.S. Cl. CPC A23J 1/14; A23J 3/227; A23V 2002/00; A23P 30/20; A23J 3/26; A23L 33/185

(57) ABSTRACT

A method of processing an oil cake and/or extraction meal and/or a powder from portions of seeds containing oil, such as mustard, crambe, sunflower, pumpkin seeds, hemp, linen, or rapeseed, includes subjecting the seed material to a heating and to a texturing for forming a foodstuff that contains fiber.

### CROSS-REFERENCE TO RELATED APPLICATION

This application claims priority from Application No. EP 18 000 828.6 filed Oct. 25, 2018, the entire content of which is incorporated herein by reference.

### FIELD OF THE INVENTION

The invention relates to a method of processing an oil cake or a powder from portions of seeds containing oil such as mustard, crambe, sunflower, pumpkin seeds, sesame, hemp, linen, or rape (canola), in particular rapeseed, excluding soy and to a foodstuff.

### BACKGROUND OF THE INVENTION

It is known to use seeds containing oil by pressing to acquire oil and/or to obtain an oil cake for the feeding of animals or humans. It is further known from DE 199 37 081 C1 to dehull rape grains, for instance, before their pressing and to separate the kernel fractions and the husk fractions from one another. Not only the quality of the oil acquired from the kernel fractions is thereby improved by the removal of antinutritive ingredients of the hulls, but also the quality of a rape cake possibly acquired from the kernel fractions is equally improved due to the separation of crude fiber. The oil cake produced after the pressing out of oil contains protein and to this extent has a high value for the diet of humans or animals. However, the oil cake has a hard, porous, crumbly structure and is not therefore easily suitable as a human foodstuff. There are therefore processes to utilize such oil cakes as a raw material for a subsequent protein concentration or protein isolation to thus be able to concentrate the protein produced and to be able to integrate it into foodstuffs produced later. Such processes are, however, very complex and/or expensive energetically and with respect to water consumption.

It is the underlying problem of the invention to facilitate the utilization of an oil cake (expeller) or of extraction meal for a high protein diet.

### SUMMARY OF THE INVENTION

The invention solves this problem by a method having the features described herein and by a foodstuff having the features described herein. Reference is made to further embodiments and features of the invention, that are disclosed herein.

It is possible by the method in accordance with the invention to form a food that is stable in shape and that contains fiber directly from the oil cake (expeller) or from a powder generated by comminution or oil extraction without the sidestep of a protein concentration or protein isolation. No chemical splitting of the already existing oil cake or powder and no later compounding to form a foodstuff therefore have to take place. An elastic, fibrous, and pleasantly soft foodstuff is produced by the method whose flavor can be set in a variety of ways by aromas, spices and similar and that can optionally be made to last by preservatives. The fibers are not thin threads in the sub-millimeter range, but can rather have a diameter of one to a plurality of millimeters—as with meat fibers.

Following the method step of forming the oil cake, the introduction of the oil cake material—optionally defatted—into a further process such as in an extruder can therefore be initiated without any intermediate step, in particular without the addition of further energy or of a solvent. The oil cake therefore does not have to be physically and/or chemically processed; in particular no portion of the oil cake is washed out as with an isolate or a concentrate, but the oil cake can be used as a whole (optionally defatted). This is a substantial difference from known methods in which a protein isolate or a protein concentrate is the starting point.

The oil cake is in particular formed from rapeseed since rape is available in large amounts and anyway accrues in the oil pressing as a by-product of such oil cakes and is particularly advantageously supplied to a further utilization as a foodstuff. Such a rape oil cake is available in organic quality from dehulled rapeseed for approximately 35 eurocents a kilogram—unlike a rape protein isolate that costs approximately €8 a kilogram. The simplicity of the method now formed is also remarkable.

If the oil cake or the powder is favorably formed from rapeseed dehulled before the pressing, almost no, but a maximum of 3%, visually disruptive (dark) and very hard shell elements are contained in the oil cake so that such elements can also be non-disruptively present in the finished end product. Antinutritive fractions contained in the shell such as waxes or tannins can thus also practically not enter up to and into the foodstuff output as the end product. The use of dehulled seeds is therefore particularly recommended.

The material of the oil cake can advantageously be ground to a powder or directly introduced into at least one extruder in dependence on the consistency so that a heating up to a cooking process and a simultaneous output take place through the pressure and the friction so that the texturing automatically takes place in the direction of conveying without any further measures. The starting protein that is moist through the addition of water is exposed to strong shear forces at high pressure and at a high temperature in the extruder, whereby a partial unfolding and stretching of the globular proteins takes place that are subsequently oriented in the direction of flow.

The friction can in particular take place at a cooled discharge nozzle. The latter can include a double jacket that is flowed through by water and is thereby cooled. The water has a temperature of, for example, 5° to 10° C.; the extrudate that is conducted through has a temperature, for example, of 130° C. The extrudate solidifies at the cool walls, whereas it runs on at the center of the cross-section of the discharge nozzle and thus forms the fibers of the texture. They can be infinitely long in continuous operation and can have a thickness in the range from one to a plurality of millimeters such as also corresponds to meat fibers. Suitable pieces can then be cut off by stamping or sawing. They can also in particular be given a “freeform” such as in a natural piece of meat on stamping.

The discharge nozzle has a length, for example, of one to two meters. The cross-section can correspond to the finished dimension of the desired meat substitute, that is, it can be approximately 2 to 4 centimeters high and approximately 8 to 12 centimeters wide.

Alternatively, a spin process would also be possible in which real fibers are formed by pressing the material from a spin nozzle into precipitation baths triggering the coagulation.

Since a rape oil cake or a corresponding powder includes only approximately 38 to 40% protein depending on the type and since a higher protein content can be required for a mechanical stability of the end product, the material of the oil cake or of the powder can favorably be mixed with a further material containing protein, for example pea protein. Other vegetable proteins, for example lupine, sunflower, or other proteins, or also animal proteins (for instance from eggs or fish meal) can be used to increase the protein content to 45 to 50% of the volume and can in particular be blended with the oil cake or with the ground powder so that a powdery, uniformly mixed compound is produced that can be introduced into the extruder.

A dispensing with the addition of a further material containing protein can also be possible so that the foodstuff is then formed solely from the oil cake of one type, for example rape.

The extrudate advantageously forms a strand that contains fiber as a pre-starting product that is stable in shape per se and that can be divided into pieces by cutting or stamping.

This pre-starting product can be divided into portions by cutting or stamping and can be completed, for example as an end product serving as a meat substitute, that can be individually packaged and handled, by the addition of aromas, spices, and other substances influencing the flavor. The value creation is very high due to the simplicity of the process.

The method can be operated continuously or quasi-continuously using the extruder and can also produce a high efficiency in industrial use and can produce large volumes.

The invention also forms a new foodstuff from a solid body that contains protein, that contains fiber, and of which at least 90% of its volume is formed from rape. Such a foodstuff has previously not been known and can be handled per se.

For the desired stability and as a support in the manufacturing process, the foodstuff advantageously has a raised protein content in that 5% to 10% of its volume is formed from a further protein, in particular a vegetable protein, in addition to the main protein provider of rape.

Such a foodstuff can be used without problem as a meat substitute due to its fibrous consistency and the possibility of seasoning and aromatization.

Further advantages and features of the invention result from embodiments of the subject matter of the invention shown in the drawing and described in the following.

### BRIEF DESCRIPTION OF THE DRAWINGS

There are shown in the drawings:

FIG. 1 is a rough schematic flowchart of a method in accordance with the invention;

FIG. 2 is a schematic view of an oil cake that can serve as a starting material;

FIG. 3 is a schematic view of a textured end product that contains fiber; and

FIG. 4 is a schematic, perspective view of an extruder end having a cooling channel through which the formed pre-end product is outwardly conveyed as a strand.

### DETAILED DESCRIPTION OF THE INVENTION

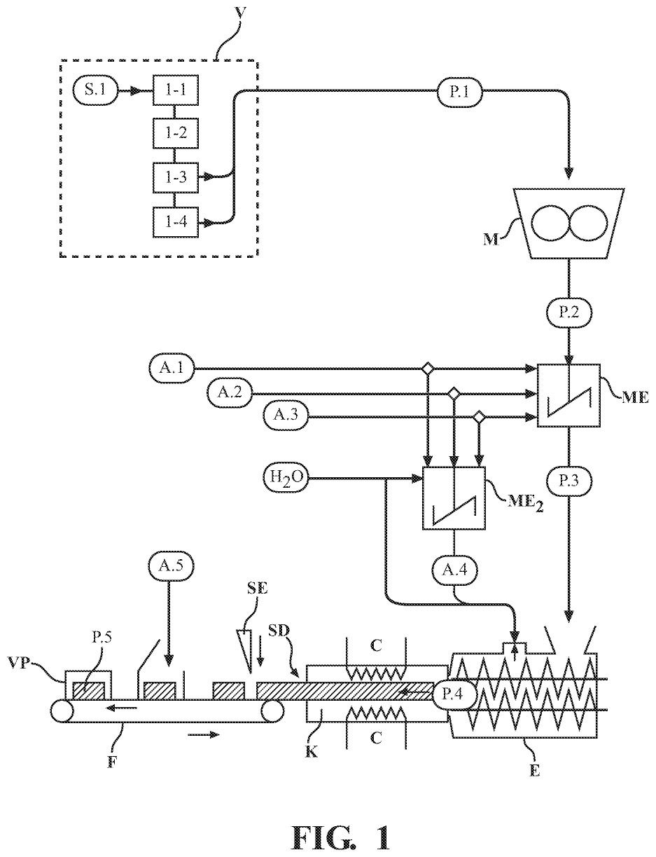

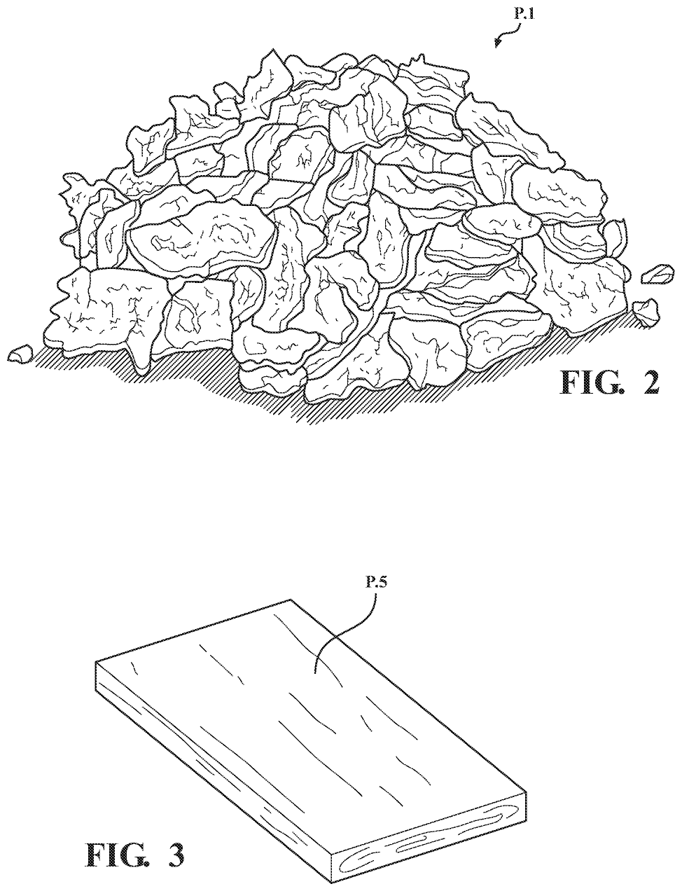

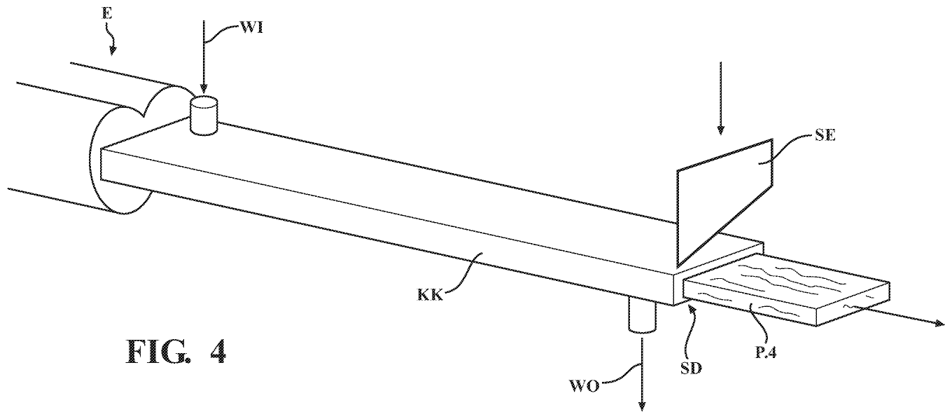

In accordance with the flowchart shown in FIG. 1, a method is shown at whose end a foodstuff is obtained as a product P.5 that is divided into pieces and can, for example, be used as a meat substitute or as a meat analogue. This product P.5 also has a high protein content without any protein concentration or protein isolation and is therefore very valuable for the diet.

Seeds S.1 containing oil such as mustard, crambe, sunflower, pumpkin seeds, hemp, linen, or in particular rape serve as the starting product for the process and are, for example, first conditioned in an oil seed processing process V in a step 1-1, are then subjected to dehulling in a step 1-2 before the kernels are pressed without any hull fractions where possible—once or multiple times in step 1-3 or the hulls are subsequently removed by a suitable process. The total processing process V is here in particular carried out at a low temperature (so-called cold pressing) to prevent a denaturation of the proteins. This means that the seeds are supplied to the press at room temperature or at environmental temperature without any previous hydrothermal conditioning. The seed moisture is typically approximately 6 to 8 percent water content and the resulting press temperature in a cold pressing is approximately 40 to 60 degrees Celsius.

An oil extraction (nota bene: not a protein extraction) can follow as step 1-4 that lowers the residual content in the remaining oil cake or powder P.1 to, for example, approximately 1%—from a previous approximately 8% that remains after pressing. The powder or the oil cake P.1 can then be obtained for the further process from step 1-3 or 1-4.

In this further process for preparing an oil cake or powder P.1 from portions of seeds containing oil, the material of the oil cake or powder P.1 is subjected to a heating and to a texturing to form a food A.5 that contains fiber—here by way of example in an extruder E.

In the present example here, the oil cake or the powder (that can also be formed differently than described above) is formed from rapeseed S.1. In rape types typical today, it contains approximately 38% protein, approximately 12% fat, and approximately 50% carbohydrates in volume. However, rape types are already being tested that have a higher protein content.

If the material P.1 is an oil cake composed of contiguous pieces of different sizes, such as shown in FIG. 2, for instance, it can still be ground in a grinder M to a meal or powder P.2. A particle size of a maximum of 5.0 millimeters in extent results therefrom. The grinding can also be dispensed with depending on the starting material P.1.

Depending on the protein content the starting material P.1 has, it may additionally be necessary to raise the protein content by adding a further protein A.1. If such an admixture is necessary, it can in particular be added to a mixing unit ME that uniformly blends the added protein with the starting compound of oil cake or powder P.1, optionally after a further grinding as meal P.2.

Different vegetable proteins or also animal proteins can be considered as a further protein, for example pea protein. Other vegetable proteins, for instance from lupine, sunflower, or similar, are also possible. Additionally or alternatively, protein from animal sources can also be added if a purely vegan product is not to be produced, for example egg, whey powder, albumen, fish meal powder . . . . The addition can take place in liquid or solid form, in particular in powder form, depending on the embodiment.

Independently of the source of the added protein, the protein content in the compound P.3 mixed in this manner can be increased by the addition to approximately 45%, in particular to more than 50%, which benefits the uniform appearance and mechanical stability of the finally formed product P.5.

Furthermore, aromas A.2 and/or preservatives A.3 can also be added to the mixing unit ME—likewise in liquid or solid form—so that the mixed compound P.3 obtained can have already reached its final composition in a homogeneous distribution.

It is additionally or alternatively also possible that liquid additions of protein A.1, of aromas A.2 and/or of preservatives A.3 are mixed in advance with water (H₂O) in a further mixing unit and are then directly introduced as an aqueous phase A.4 into an extruder E and are only blended with the compound P.3 there.

In both cases, the oil cake meal P.3 from the material of the oil cake or the powder P1 is here introduced into at least one extruder E. The extruder E can be a screw extruder or a ram extruder that can additionally be heated. The starting compound P.3 is intimately mixed and heated in the extruder E, that is preferably a twin screw extruder, as is indicated in FIG. 4, and that can introduce a large amount of energy into the material. The supply and mixing of water or of the above-described aqueous phase A.4 with additives (for example, protein, aromas and/or preservatives) result in a conversion process of in particular the protein fraction as a component of the rape oil cake meal P.3 at the high temperature and pressure. In this process step that is also known as “high moisture extrusion cooking” a cooking of the material takes place with a simultaneous fiber formation (texturing). The proteins swell up and cross-link. The texturate P.4 thus formed can be pressed out through a slotted nozzle SD having a suitable height and width that can already determine the final height and final width of the product. The height of the slotted nozzle is typically approximately 1 to 4 cm, the width, in contrast, is approximately 5 to 15 centimeters.

A cooling unit K in which the texturate P.4 is subjected to a fast cooling C is connected downstream of the extruder E in the conveying direction. A strand that contains fiber, that is stable in shape per se, and that can be divided into pieces by cutting is thereby produced as the pre-starting product of the method. It is an oil cake texturate P.4 having an aligned fibrous, elastic structure.

This cooling unit K in particular forms a cooling channel KK that can be a plurality of ten centimeters up to approximately two meters in length and is, for example, double walled or is surrounded by cooling coils. Cooling water that is introduced at a water inlet WI and that can be led out at a water outlet WO can then run within the double wall. A discharge temperature of approximately 60 to 70° C. of the pre-end product P.4 is thus possible at the slotted nozzle SD. The inlet temperature in the cooling channel was in contrast considerably above 100° C., for example 150° to 170° C. A very fast cooling of the outer regions of the extrudate takes place by the water inlet WI located there while the core still remains warmer. This promotes the formation of long fibers.

This initially strand-like texturate P.4 can, as can be recognized at the bottom in FIG. 1, be able to be divided into portions by cutting or stamping by one or more cutting units SE and can then be conducted on a conveyor F. An automated packaging VP of the foodstuff P.5 divided into final portions and stable in shape is likewise possible here. Further ingredients and/or additives A.5 such as aromas, spices, and other flavor-influencing substances such as a sauce or an herb crust can be supplied to the product P.5 beforehand. The product present in manageable pieces can thus be able to be produced as an end product serving as a meat substitute. Both the shape and haptics and the flavor can be designed, for example, in the manner of a schnitzel. Nor does the shape have to be approximately rectangular, as shown schematically here, but a freely shaped stamping is also possible as desired.

The manufacturing process can also be carried out completely without protein isolation or protein concentration on a change of details. No waste water is also produced, but the water H₂O supplied directly or indirectly is completely installed in the product P.5.

The method can be operated continuously or quasi-continuously for a high efficiency.

The end product P.5 that can also be manufactured by different method steps thus forms a previously unknown foodstuff from a solid body that contains proteins, that contains fiber, and of which at least 90% of its volume is formed from rape here. An organic quality can also be simply achieved here.

Where necessary, only approximately 5% to 10% of its volume are here formed from a further protein, in particular from a vegetable protein.

The foodstuff is nevertheless usable as a meat substitute due to the flavor-forming substances.

The rape cake P.1 that contains protein is therefore as a rule not first fragmented and chemically modified, but it is at the most mixed with a further protein A.1 so that the protein content is increased and is then converted directly and only using physical processes into a foodstuff P.5 that contains fiber. A protein extraction or protein isolation can be fully dispensed with and does not take place in the entire process.

### REFERENCE NUMERAL LIST

S.1 seeds containing oil
V oil seed processing process
1-1 conditioning
1-2 dehulling
1-3 pressing
1-4 deoiling
P.1 powder or oil cake
M grinder
P.2 ground meal or powder
A.1 protein
A.2 aromas
A.3 preservatives
ME mixing unit
P.3 mixed compound
ME2 second mixing unit
H₂O water
A.4 aqueous phase
E extruder
P.4 oil cake texturate
K cooling device
C cooling
SE cutting elements
P,5 foodstuff (product)
VP packaging
WI water inlet
WO water outlet
KK cooling channel

1.-18. (canceled)

19. A method of processing an oil cake and/or extraction meal and/or a powder from portions of seeds containing oil, comprising the steps of:
providing seed material comprising oil cake and/or extraction meal and/or powder from portions of seeds containing oil;
heating the seed material; and
texturing the seed material;
thereby forming a food that contains fiber.

20. The method of processing according to claim 19, wherein the portions of seeds containing oil comprise portions of mustard seed, crambe seed, pumpkin seeds, sesame seeds, hemp seeds, linen seeds, sunflower seeds, or rapeseeds.

21. The method of processing according to claim 19, wherein the portions of seeds containing oil comprise portions of rapeseed.

22. The method of processing according to claim 21, wherein the portions of seeds containing oil comprise portions of rapeseed dehulled prior to a pressing.

23. The method of processing according to claim 19, further comprising introducing the seed material into at least one extruder.

24. The method of processing according to claim 23, wherein the heating step is a cooking step and the texturing step comprises texturing the seed material in the extruder.

25. The method of processing according to claim 24, wherein the extruder comprises a discharge nozzle that forms a cooling channel for the texturing.

26. The method of processing according to claim 25, wherein the discharge nozzle predefines the end height and the end width of an output pre-end product.

27. The method of processing according to claim 19, further comprising cross-linking the seed material with a further material containing protein prior to the heating step.

28. The method of processing according to claim 27, wherein the cross-linked seed material and further material comprises a mixture having a protein content of at least 45%.

29. The method of processing according to claim 27, wherein the cross-linked seed material and further material comprises a mixture having a protein content of at least 50%.

30. The method of processing according to claim 27, wherein the further material comprises pea protein.

31. The method of processing according to claim 19, wherein the method is carried out without a protein isolation or protein concentration.

32. The method of processing according to claim 19, wherein the seed material comprises oil cake and the oil cake is supplied directly to an extruder while mixing with water.

33. The method of processing according to claim 19, wherein a pre-end product of the method is a strand that contains fiber, that is stable in shape, and that can be divided into pieces by cutting.

34. The method of processing according to claim 33, further comprising:
dividing the pre-end product into portions by cutting or stamping;
completing the pre-end product an addition of aromas, spices, and other flavor-influencing substances to form an end product serving as a meat substitute.

35. The method of processing according to claim 19, wherein the method is operated continuously or quasi-continuously.

36. A foodstuff composed of a solid body that contains protein, that contains fiber, and of which at least 90% of its volume is formed from rapeseed.

37. The foodstuff in accordance with claim 36, wherein 5% to 10% of the volume of the foodstuff is formed from at least one further protein.

38. The foodstuff in accordance with claim 37, wherein the at least one further protein comprises a vegetable protein.

39. The foodstuff in accordance with claim 36, wherein the foodstuff comprises a meat substitute.
